(19) United States
(12) Patent Application Publication
(10) Pub. No.: US 2002/0178454 A1
(43) Pub. Date: Nov. 28, 2002

(54) Broadcast television and satellite signal switching system and method for telephony signal insertion

(76) Inventors: Mark J. Antoine, Lafayette, LA (US); Michael G. Ellis SR., Alpharetta, GA (US); Peter Anthony Cascio, Lawrenceville, GA (US)

Correspondence Address: Carl M. Napolitano, Allen, Dyer, Doppelt, Milbrath & Gilchrist, P.A., 255 S. Orange Avenue, Suite 1401, P.O. Box 3791, Orlando, FL, 32802-3791, US

(21) Appl. No.: 10/076,080

(22) Filed: Feb. 14, 2002

Related U.S. Application Data
(60) Provisional application No. 60/268,629, filed on Feb. 14, 2001.
(60) Provisional application No. 60/344,968, filed on Dec. 21, 2001.

(51) Int. Cl. H04H 1/00; H04N 7/20; H04N 7/173

(52) U.S. Cl. 725/106; 455/3.02; 455/3.05; 725/63

(57) ABSTRACT

A system switches multiple broadcast signals from satellite and cable for transmission through a single coaxial cable to television receivers while managing use of the broadcast signals through telephony signal insertion and passage of a telephony signal and an RF signal on the single coax between a multiswitch and a triplexer operable with the receiver. A telephony interface operates with the multiswitch through a data access arrangement (DM) device for bringing outside telephone signals to the multiswitch. The triplexer includes a subscriber line interface circuit (SLIC) for providing telephony information to the receiver. The multiswitch and telephony interface route telephony information to the receiver.

### CROSS REFERENCE TO RELATED APPLICATIONS

This application incorporates by reference and claims priority to application Serial No. 60/268,629 filed Feb. 14, 2001 for SATELLITE SIGNAL RECEIVING SYSTEM AND METHOD FOR DIAL TONE INSERTION, and Application Serial No. 60/344,968 filed Dec. 21, 2001 for SATELLITE SIGNAL DILA TONE INSERTION DEVICE AND METHOD, all commonly owned with the present invention.

### FIELD OF THE INVENTION

The present invention relates generally to electronic signal coupling of multiple signals onto a coaxial cable transport, and in particular to a system and method for providing telephony interfacing to a broadcast television and satellite systems.

### BACKGROUND OF THE INVENTION

Typically, installers of satellite dishes and receivers connect three different signals to the satellite receiver in order for a cable television system to work properly. A connection is made from the antenna, generally a satellite dish, to the receiver. A second connection to the receiver may then include an off air antenna or cable signal so that the receiver can access local television (TV) signals should the consumer/customer wish to view local TV stations. Thirdly, the installer must provide for a telephone signal (herein referred to as dial tone) connection for use by the customer and the satellite provider.

The service provider typically wants to access the satellite receiver for verifying the location of the receiver. It is of value to the provider to know when a customer is changing locations of the receiver. Also, if multiple receivers are being used, it is desirable for all receivers using a common satellite dish, dishes, antenna, or antennas to be operable with the same phone line. Telephone connection verification is useful in preventing piracy of the satellite signal. Satellite providers also use the telephone connection to down load any pay-per-view or other purchases made during a billing period.

Currently, installers use a device often referred to as a multiswitch for combining a satellite signals and an off-air antenna or cable television signal. This new combined signal is then sent out through the output connector of the multiswitch to various coaxial cable (coax) connections located throughout a house or structure, by way of example. Where the coax exits at an interior wall of the house, the installer typically attaches a device called a device called a diplexer that serves to separate the combined signals back out based on frequency bands so they can be connected to the Satellite receiver at their respective input port locations.

The third and last signal, as above described, is as important as the first two signals. Yet it is typically not combined with the first two signals. As a result, the installer must go through a time consuming and often difficult process to provide the dial tone signal. In many situations currently known in the art, a telephone outlet is not conveniently located near preferred television or audio/visual system locations. The installer may choose from available solutions, herein described by way of example to include: “running” new wire to each location of a satellite receiver, a normally difficult and labor intensive procedure; accessing a telephone outlet that is closest to the receiver and running a line within the house, also a labor intensive procedure typically requiring the installer to hide the wire so that it is not exposed for view as it runs across a finished room within the house; and as another option, using wireless phone jacks. However, as is well known in the art, “wireless” is a misnomer in that typical devices require electrical wiring to be run in a home to transmit the phone signal. Further, there are problems associated with the use of wireless phone jacks. In many instances there is too much electrical interference within the setup. An installer must move the base jack to several different electrical outlets in order to minimize interference. Also, if there is an electrical surge, the phone jacks are prone to problems that require the installer to make a service visit in order to get the phone signal reconnected to the satellite receiver. Such methods for providing a dial tone to the satellite receiver is costly from both the labor and materials points of view and typically add significant cost to the overall system installation.

Signal coupling devices and methods for combining CATV and telephone signals are suggested in the art. By way of example, U.S. Pat. No. 5,027,426 to Chiocca, Jr. discloses the use of a diplex filter to place telephony and RF signals on a single coaxial cable (coax), but uses the shield of the coax as the needed second conductor. In practice, the shield typically can be unintentionally grounded during installation, causing undesirable telephony signal transmission problems. U.S. Pat. No. 6,144,399 to Manchester et al. discloses a passive system for merging a telephone and broadband signals onto one cable, and by way of example teaches that the outer conductor must remain ungrounded to avoid shorting the telephone electrical to earth ground. Telephony signals are dc coupled onto the inner and outer conductors of the coaxial cable, while the information wire and reference ground of the broadband signal are ac coupled onto the inner and outer conductors of the coaxial cable. The present invention seeks to overcome such problems by avoiding the need to use both the center conductor and the shield for transmitting the telephony signals and employs the use of digital square wave pulses used by microcontrollers located at each end of the single coax to communicate telephony information to each other. U.S. Pat. No. 5,896,556 to Moreland et al. uses the modulation and demodulation of the telephony signals to an RF frequency over the coax. Further, the suggested telephony interface is to be connected at only one place in the system, and prior to any splitters on the coax cable. The present invention seeks to reduce costs and minimize components, and as a result discloses transmission of the telephony baseband requiring no modulation.

### SUMMARY OF THE INVENTION

In view of the foregoing background, it is therefore an object of the present invention to provide for telephony signal transmission such as dial tone (DT) signal insertion into a satellite system. It is further an object of the present invention to provide DT insertion and management of satellite system, cable television, and local antenna signals using a single radio frequency (RF) cable. These and other objects, features and advantages according to the present invention are provided in a system including a multiswitch and triplexer that ends all of the various “fixes” that the installer must solve or go through. The system comprises a switch for receiving a plurality of radio frequency signals and providing a selected signal output to a coaxial cable in response to a control signal, a telephony device for receiving a telephony signal, a controller operable with the switch for providing the selected signal output and operable with the telephony device for receiving telephony information and a baseband communications system operable with the controller and the telephony device for modifying the telephony signal as characterized by a control signal for transmitting a modified telephony signal through a single center conductor wire of the coaxial cable. One preferred embodiment includes a triplexer for connection to the single cable for receiving the modified telephony signal and the selected radio frequency signal, the triplexer further having a controller communicating with the controller through the single conductor wire and an interface device for connection to a receiver. A method aspect of the present invention includes receiving a plurality of radio frequency signals, processing the radio frequency signals for transmitting to a switch, selecting one radio frequency signal from the plurality of radio frequency signals for transmission through a single cable, receiving a telephony signal, modifying the telephony signal as characterized by a digital control signal for transmitting a modified telephony signal through a single conductor wire of the single cable, receiving the selected radio frequency signal and the modified telephony signal, processing the modified telephony signal for reforming the telephony signal from the modified telephony signal, and transmitting the telephony signal and the selected radio frequency signal to a receiver.

The system of the present invention permits a merging of all three desired signals, including a satellite signal, off-air antenna or cable television, and a telephone signal. Further, these signals can be distributed to multiple locations so that the satellite receivers can work independently of one another. As a result, an installer can simply connect a satellite signal, an off-air antenna, and a telephone signal, all at one easy location in a single multiswitch device. The installer also has the option of connecting the telephone signal at the triplexer instead for providing distribution of dial tone to other triplexers and receivers through the multiswitch in situations where a telephone signal is not present at the multiswitch location. The installer connects the existing cabling to the outputs of the multiswitch device and delivers all three signals over one coax to each receiver location. This triplexer separates out the multiplexed signals so that the installer can connect them to their respective connections on the receiver. This is an easy solution for the installer or the homeowner. A single system that can merge all three signals and distribute them to any location in the home using the single existing cabling and each receiver can act independently of each other. There is a savings in time and the installer does not have multiple devices to connect or buy in order to handle the telephone signal separately.

With the system and method of the present invention, the installer simply connects the satellite signal and the off-air/ cable to multiswitch just as he currently does with existing multi-switches. Next, instead of wasting valuable time trying to figure out which “telephone line connection fix” is best for the particular job at hand, the t installer simply connects a phone signal to the new multiswitch or triplexer. This is a great savings in cost over the current solution not only in reducing the cost of associated equipment the installer must purchase and the labor that is involved, but it also reduces time lost on a job due to down time as the installer tries to figure out which “fix” is best. Also it takes all of the guesswork out any particular job for a less experienced installer. It is expected that the installer will find a phone line located near the multiswitch or one or the triplexers to which to connect. After he has located a phone signal, the installer simply plugs it into the multiswitch or triplexer that is near-by. The system of the present invention does the rest of the work including delivering all three needed signals to all locations in a home across existing coax cable or wire.

To an end user, the multiswitch and triplexer of the present invention offers a major cost savings in the labor required for installation, reduces the cost of associated equipment needed to connect a telephone service to a satellite receiver, and ensures an esthetically pleasing system installation. To the satellite provider it helps to ensure that each installation has a phone connected to the satellite receiver so that it can verify the location of each receiver, download all pertinent charges from the many different pay-per-view options which also helps to increase the satellite provider's revenues because all installations will now have a phone signal properly connected resulting in an increase in orders due to the ease of the ordering process, help to end theft or pirating of the satellite signal, and helps to lower installation costs when compared to current satellite jobs which is most desirable in light of the current “free” installation programs satellite providers are offering.

The system of the present invention, which combines three needed signals and transmits the combined signal over a coax that already exists in a home or structure, is a needed accomplishment. The system does not simply combine the signals. It manages the transmission of radio frequency and telephony signals and processes programming and telephony requests from multiple receivers to which it communicates. One embodiment of the present invention includes a triplexer. The receiver controls the multiswitch using its own system protocol that it transmits to the multiswitch via a coaxial cable connection through the triplexer to the multiswitch output RF connector for channel selection and telephone connection. The triplexer modifies the protocol of the receiver and creates a unique protocol to which the multiswitch will respond. The duties of a multiswitch include analyzing the protocol and transmitting requested signals to each receiver, which may differ based upon the selection in each receiver. By way of example, satellite channels have pre-assigned signals that are transmitted by the satellite provider. Typical receiver channel selection protocol includes using a control signal varying between a 13 volts DC or 18 volts DC level with or without the presence of a 22 kHz signal. The triplexer analyzes the receiver channel selection request as well as any request for a dial tone connection. The multiswitch must process each request from a receiver then send the proper channel and/or telephony connection to that receiver. The microcontroller operable with the multiswitch communicates with the controller in each triplexer through the coax in order to determine if a dial tone is present at any of the triplexers or at the multiswitch in order to process channel and telephony path connections. Current system protocol signals, 13 and 18 volt plus the 22 kHz signal, make it difficult to transmit the phone signal simultaneously. With the present invention, between the multiswitch and the satellite receiver, the 18 and 13-volt signals and the 22 kHz signal are changed to a new and different format to avoid interference of these signal voltages with the telephone signal. One embodiment of the present invention as will be later described in further detail includes a triplexer. The request is then processed and transmitted back to the triplexer. Before it can be transmitted, the requested channel must be changed to the new format. When the triplexer receives the requested channel, it changes it back to the original signal for recognition by the receiver.

While the multi-switch is processing the satellite signal, off-air antenna and phone signals are being transmitted across the coax cable or wire. Off-air/cable, phone and satellite signals must be able to operate simultaneously and not interfere with each respective signal. This allows the receiver to do multiple tasks at the same time. An example of this is a user of a satellite watching a satellite channel and at the same time receiving an incoming call. The multi-switch must now pass the phone signal to the receiver where it is recognized. Then it processes the phone signal so that a caller I.D. may be shown on the users screen where the viewer is watching a satellite channel.

Another example is a simple activation of a satellite receiver or receivers by an installer. When an installer has finished connecting a satellite, phone and off-air/cable signals, he is at a stage where they must activate the satellite receiver with the satellite provider. With the TV and the satellite on, the installer contacts the provider by phone. The satellite provider must at the time of the call be able to interact with the receiver or receivers. If the phone signal is not connected to the receiver then the provider will not activate the receiver. Therefore the multi-switch must be able to send all needed signals simultaneously to any satellite receiver that is to be activated.

### BRIEF DESCRIPTION OF THE DRAWINGS

Preferred embodiments of the present invention are herein presented as well as others that will become more apparent by referring to the following detailed description and drawings in which:

FIG. 1 is a system block diagram of one embodiment of the present invention illustrating a telephony signal insertion device operable with a multiswitch for switching satellite and cable television broadcast signals combined with telephony information for transmission over a single coaxial cable to a receiver;

FIG. 1A is a system block diagram of an alternate embodiment of FIG. 1 illustrating the telephony signal insertion device carried by the multiswitch having seven RF input signals and telephony information combined for a four way output to the coaxial cable operable with a receiver;

FIG. 2 is a block diagram illustrating an alternate embodiment of the multiswitch and triplexer of the present invention;

FIG. 2A is a block diagram of an alternate embodiment of the system of FIG. 2 in keeping with the teachings of the present invention;

FIGS. 3A and 3B are schematic block diagrams illustrating alternate embodiment of a triplexer of the present invention;

FIGS. 4 is a partial block diagram illustrating operating elements of the embodiments of FIGS. 2 and 2A;

FIG. 5 is a partial functional flow diagram illustrating a baseband communications system including a microcontroller operable with the multiswitch and triplexer of FIGS. 2 and 2A;

FIG. 6 is a schematic block diagram illustrating one implementation of the system of FIG. 5; and

FIG. 7 is a functional flow diagram illustrating an alternate embodiment of a controller of FIG. 5.

### DETAILED DESCRIPTION OF THE PREFERRED EMBODIMENT

The present invention will now be described more fully with reference to the accompanying drawings in which preferred embodiments of the invention are shown and described. It is to be understood that the invention may be embodied in many different forms and should not be construed as limited to the illustrated embodiments set forth herein. Rather, the applicant provides these embodiments so that this disclosure will be thorough and complete, and will convey the scope of the invention to those skilled in the art.

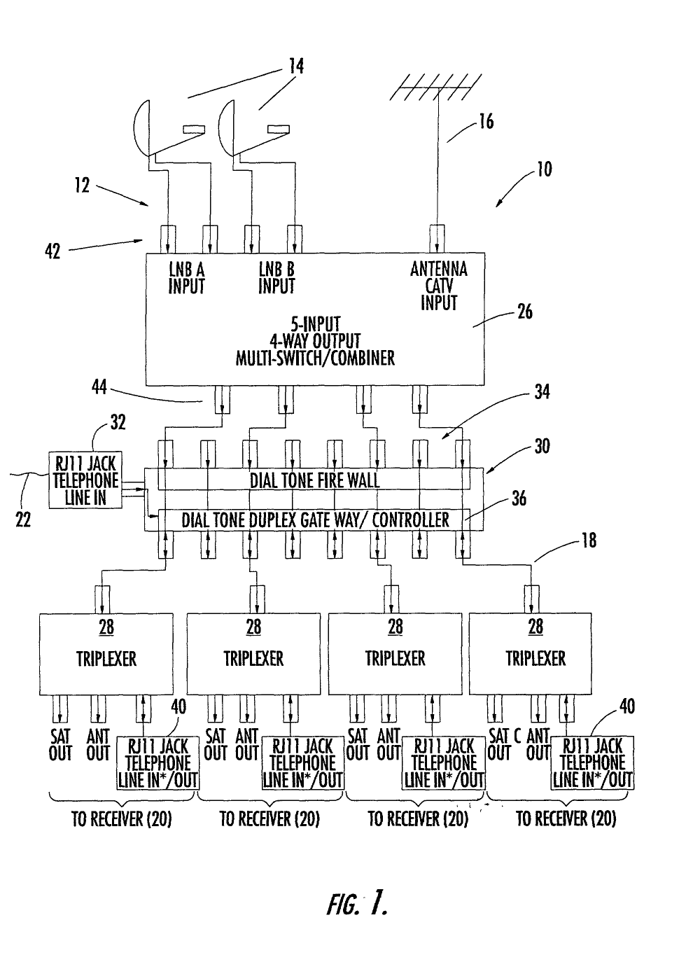

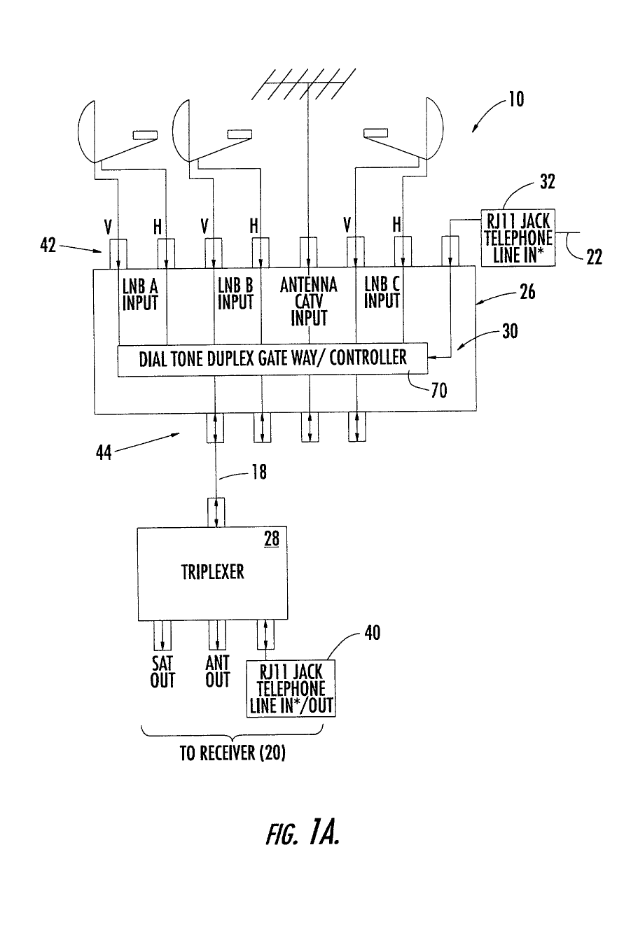

With reference initially to FIG. 1, one embodiment of the present invention as herein described comprises a system 10 for switching multiple broadcast signals 12 from satellite antennas 14 and terrestrial antennas or cable 16 for transmission through a single coaxial cable 18 to a television receiver 20 while managing use of the broadcast signals through telephony signal 22 insertion. The system 10 incorporates passage of a telephony signal 22 and an RF signal 24 on the single coax 18 between a multiswitch 26 and a triplexer 28. By way of example for one embodiment of the present invention, a telephony interface 30 provides an RJ-11 connector port 32 on an eight input (D8) 34 interface for connection to the multiswitch 26 through a data access arrangement (DM) device 36 which brings the outside phone line signal 22 into operation with the multiswitch 26. As will be described later in further detail, one embodiment of the triplexer 28 has a similar DM device for connecting to an outside line interface. The triplexer 28 also includes an RJ-11 connection 40 to a subscriber line interface circuit (SLIC) to interface to the receiver to provide a dial tone (DT) and telephony information, as will be later described.

The multiswitch 26 and telephony interface 30 route telephony information to the receiver 20 either using a triplexer as a direct connection to the wall (the single coax 18 running through the building, by way of example) or by going from one triplexer 28 through the multiswitch 26 to another triplexer to provide the telephony information such as a dial tone. This functionality is illustrated with reference again to FIG. 1, wherein a separate box is used to carry the telephony interface 30 for installer connection to a standard multiswitch for providing the telephony signal injection as will be described later in this section. Alternatively, one embodiment of the invention includes the system 10 of FIG. 1A incorporating the telephony interface 30 within the multiswitch 26 for providing the telephony information as above described. It is to be understood that a multiswitch may have multiple input ports 42 and output ports 44 as desired, and those illustrated with reference to the attached drawings are provided by way of example.

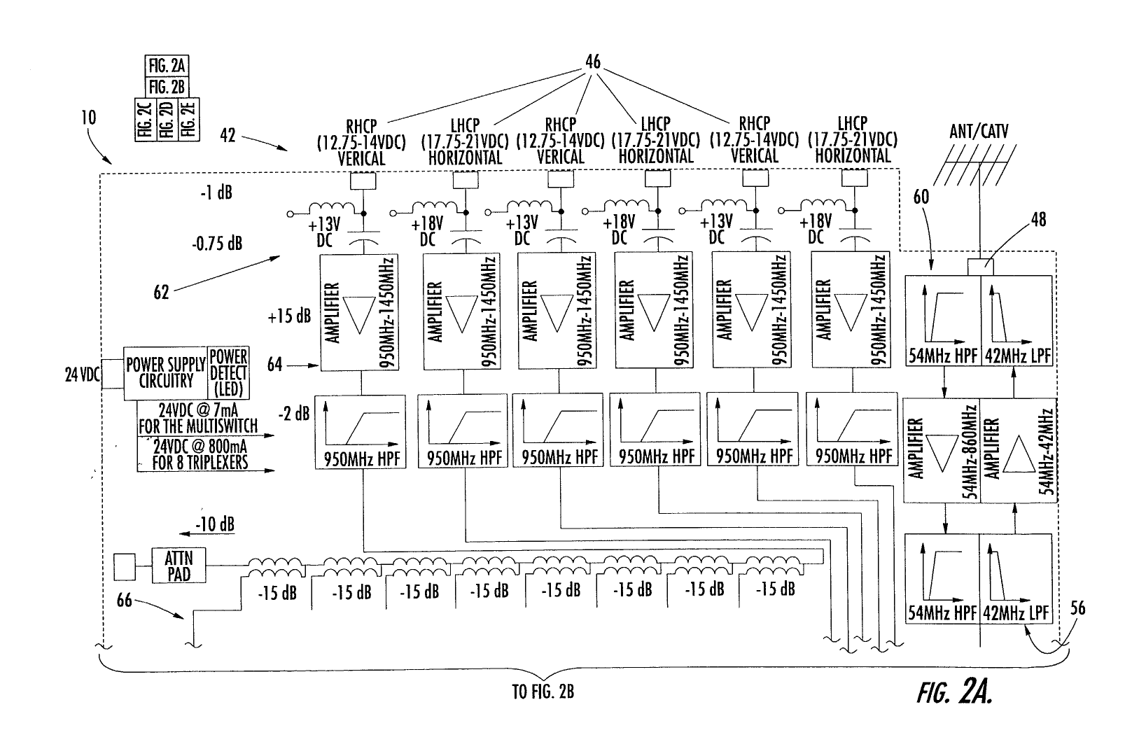

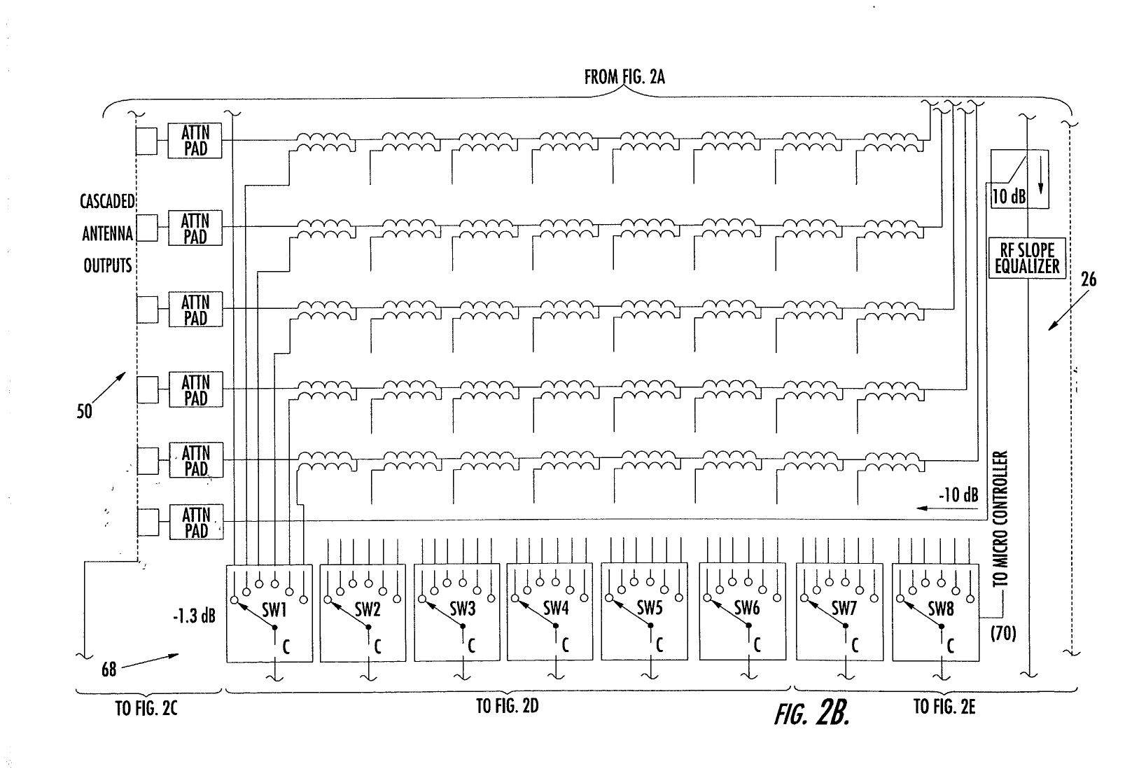

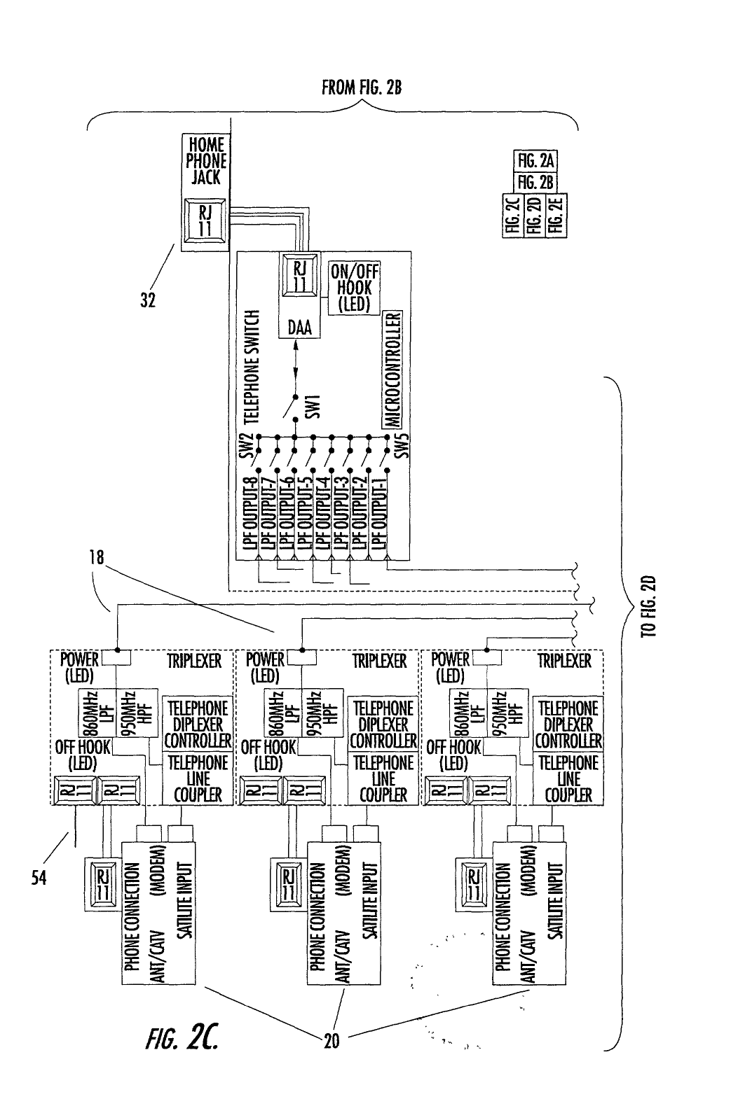

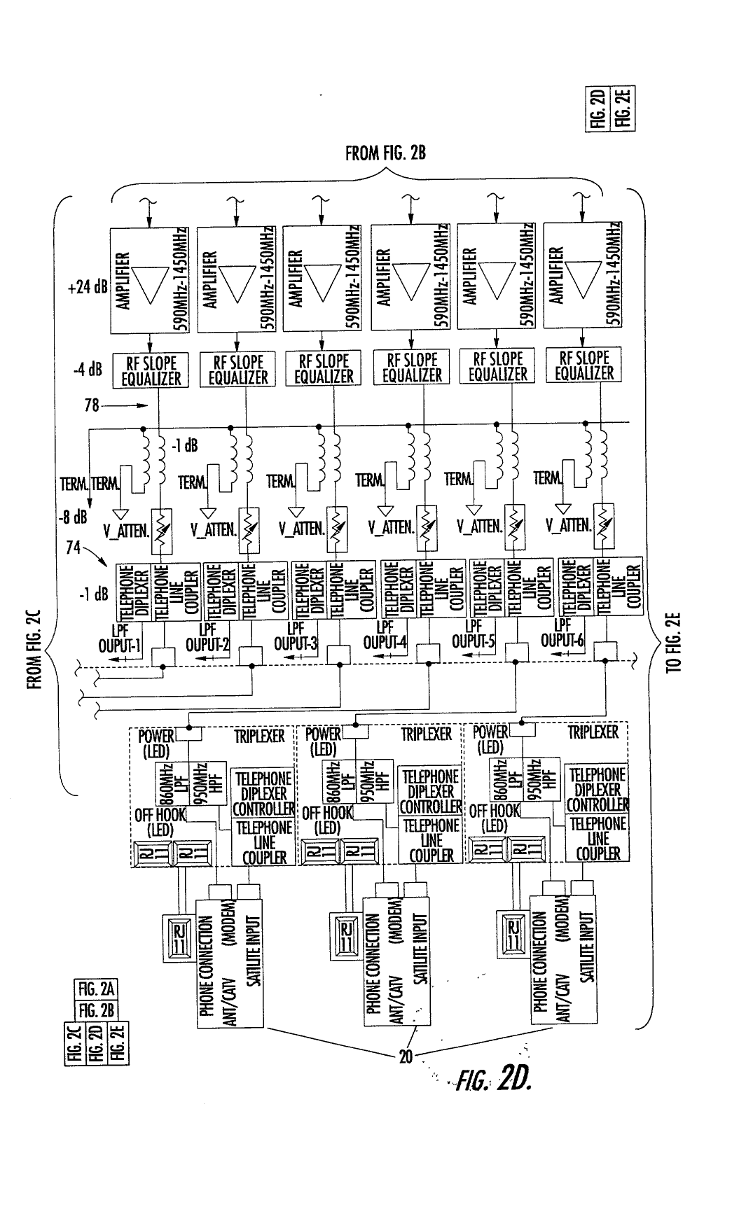

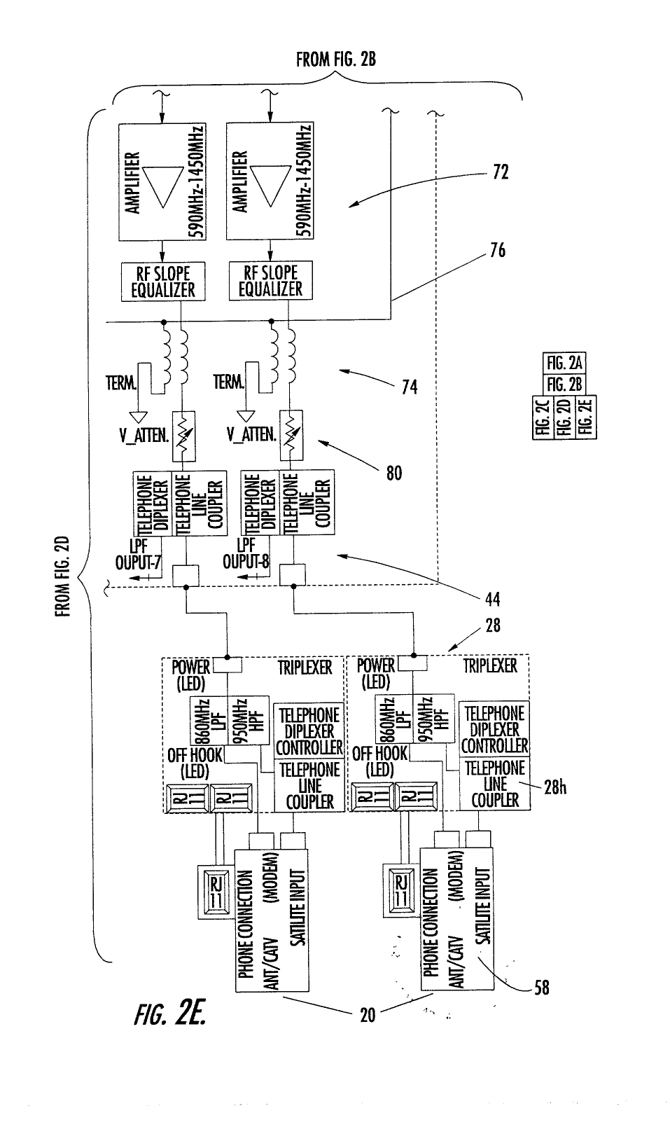

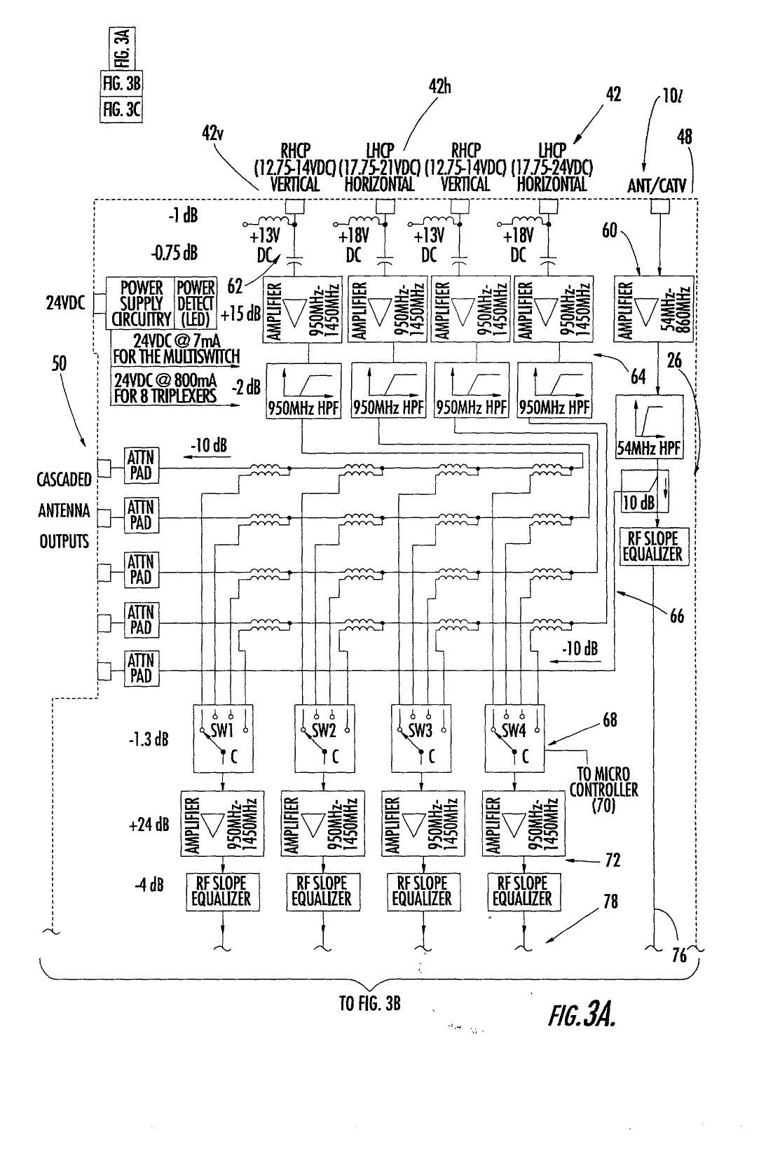

With reference now to FIG. 2, one preferred embodiment of the system 10 includes input ports 42 providing six satellite port connections 46 and a cable T.V. port feed connection 48 which as herein provided by way of example are routed through output ports 44 to as many as eight receivers 20. Cascaded antenna outputs 50 are provided after initial antenna signal processing within the multiswitch 26 for providing a feed to other multiswitch antenna ports thus allowing a cascading of the antenna ports to feed multiple receivers. As earlier described with reference to FIGS. 1 and 2, the multiswitch 26 interfaces to the triplexer 28. Alternate triplexer embodiments will include a “high end” triplexer 28h or a “low end” triplexer 28l as illustrated with reference to the system of FIG. 2B and to the triplexer diagrams of FIGS. 3A and 3B. The “high end” triplexer 28h, so named for its added features over a “low end” triplexer 29l, has a SLIC interface device 52 and a DAA interface device 54. The SLIC 52 is a subscriber line interface that allows connection to the receiver 20 and the DAA interface 54 allows connection to an outside wall line connection 54. The function of DAA device 36 is to detect a ring or connection signal to the outside ring connection and the SLIC device 52 is used to regenerate the ring and connect to the receiver 20 for providing connectivity through the multiswitch 26.

The block diagram of FIG. 2A illustrates, by way of example, a low end system 10l having the multiswitch using either a low 281 or high 28h end triplexer 28. Low end and high end as herein described refer to the cost of the equipment and allow for optional uses as desired by the installer or customer. By way of example, for the low end system 10l of FIG. 2a, four satellite inputs ports 42 are provided as well as an antenna cable connection 48. The cascading outputs 50 may or may not be included depending on the intended use of the system 10l. The system 10 optionally includes cable TV upstream components 56 to allow a cable modem 58 in place of a receiver 58 and triplexer 28 to provide cable modem access from the cable connection 48 through the multiswitch 26. By way of further example and with reference again to FIG. 2A, the low end embodiment of the system 10l as herein described has only a downstream connection 60 for providing cable TV or off air antenna programming coupled with the satellite input feeds.

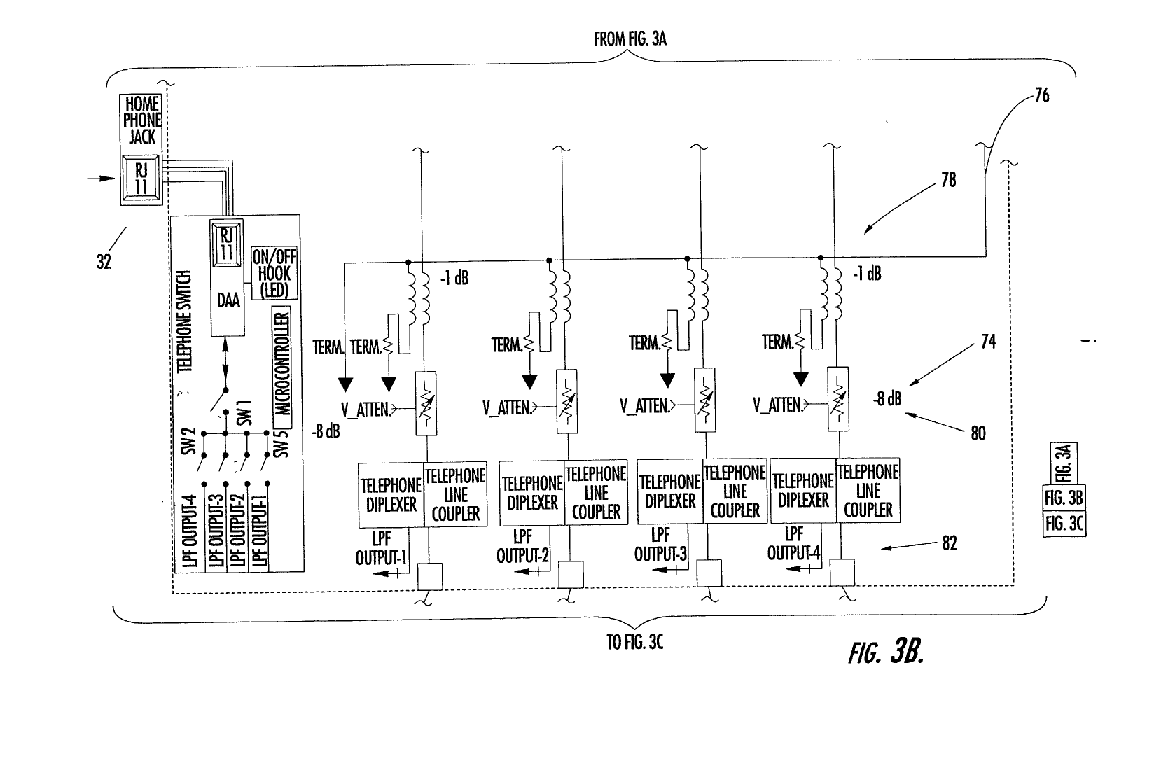

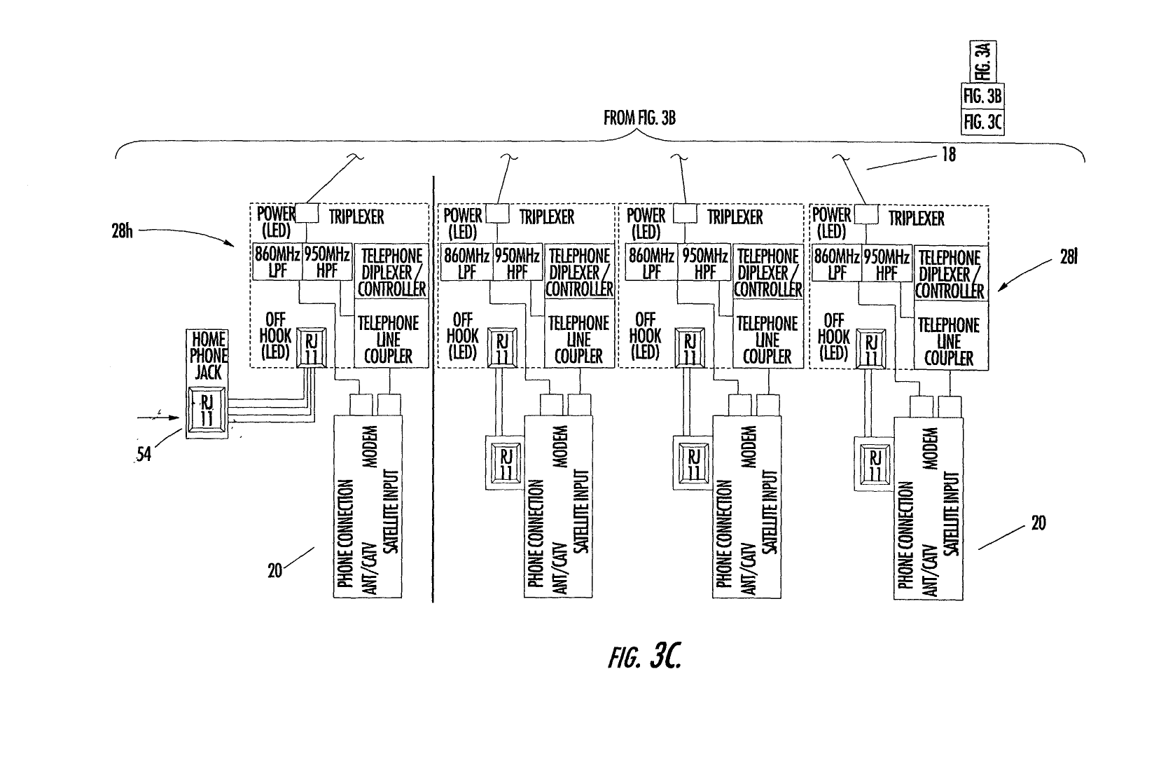

With continued reference to FIGS. 2 and 2A, the block diagram signal input flow starts at the top portion where either a vertical 42v or a horizontal 42h polarization is provided by the satellite signal antenna 14. The system provides 13 volt and 18 volt biasing 62, respectively. The 13 volt signal is referred to as vertical or as having right hand polarization, and the 18 volt signal as horizontal or as having a left hand polarization. These biases are fixed onto each of the respective ports. Signal gain and filtering 64 provide a desired 950 to 1450 MHz signal passage from the satellite antenna ports 46. Distributed couplers 66 provide uniform feeds to each of the single pole multi-throw switches 68 which will connect to each antenna port and satellite antenna port and allow a master microcontroller 70 to select the needed programming feed for routing to a particular receiver 20. The switches 68 are controlled by the master microcontroller 70 described in further detail later in this section. In the embodiment herein described, the microcontroller 70 is carried within the multiswitch housing, as illustrated with reference to FIG. 4, but it is to be understood that the microcontroller may be external without departing from the teachings of the present invention. Returning to FIGS. 2 and 2A, after the switch 68, fixed gain and RF slope equalization components 72 compensate for higher frequency attenuation due to cable losses. After the slope equalizer, a coupler 74 is provided for coupling the cable T.V. line 76 with the satellite feed 78 so that a single feed, the single coax 18 to each triplexer, can be used for connecting to the appropriate receiver 20. Variable gain 80 is provided at the output for adjusting the signal level for the satellite as well as terrestrial signals. The telephony signal is diplexed 82 with the RF signal for transmission over the common and single coax 18 to the triplexer 28. Once the signal leaves the multiswitch 26, it is carried by the coax to the triplexer 28.

As illustrated with reference again to FIGS. 2 and 2A, the triplexer 28 functions to split the satellite portion of the frequency band and the cable portion of the frequency band as well as the telephony portion of the band that is being transported across the coaxial cable 18. As illustrated with reference again to FIGS. 3A and 3B, within the telephony portion of the triplexer 28 is a microcontroller 84 that provides a control signal used between the triplexer and the master microcontroller 70 of the multiswitch 26 to control the RF and telephony switching between a triplexer and a multiswitch and a triplexer multiswitch triplexer path.

By way of example and with reference now to FIG. 4, consider one multiswitch that provides for standard satellite functionality having six feed connections 46 and a cable T.V. connection 48 as earlier described with reference to FIG. 2, as well as providing the cascading 50 from one multiswitch to another multiswitch. The cascading eliminates the need to split the satellite signals at the antenna using additional electronics and opening oneself to potential signal loss problems. As earlier described, the triplexer 28 provides a filter for separating the satellite portion of the band from the 950 to 1450 MHz to the receiver satellite input from the coax 18 and also splits out the cable T.V. portion of the band, which when including the upstream, goes from 5 MHz to 860 MHz. The other portion of the band is coupled through two resistors and passes the telephony from 300 Hz to 3400 Hz, and the controller signal of approximately 57 kilohertz out.

Consider detail with respect to the telephony portion of the system with reference again to FIGS. 4 and 3A in which a telephony interface to the “outside world” is through the RJ-11 connectors. One RJ-11 connector 88 on the triplexer 28 is connected to the SLIC device 52 that provides an interface for generating a ringing signal and connects directly to a satellite receiver 20. The second RJ-11 connector 90 connects to the DAA device 54 that detects a ring signal and is optionally connected to the outside telephone line 54 to the central office. The SLIC device 52 generally has three control lines 92 that control the state of operation and a detect line 94. The control lines 92 are generally referred to as C1, C2, and C3. The detect line 94 is used when the satellite receiver essentially picks up the line to make a telephone call, at which point the signal on the detect line of the SCIC goes low. The three control lines 92 on the SLIC device 52 can place the SLIC device in ringing mode, active mode, on hook transmission (OHT) mode, for passing the CID information, and standby mode. With continued reference to FIG. 4, the DAA device 36 has three control lines 96 to take the DAA off-hook, to allow the DAA to pass caller ID information, and for the ring detect. Both the DAA and the SLIC devices have audio in 98 and audio out 99 lines.

As above described, the system 10 of the present invention, described by the embodiments herein presented by way of example, permits a merging of all three desired signals, including the satellite signal, the off-air antenna or cable television, and the telephony signal. Further, these signals can be distributed to multiple locations so that the satellite receivers 20 can work independently of one another. As a result, an installer can simply connect a satellite signal, an off-air antenna, and a telephone signal, all at one easy location in a single multiswitch 26. Bt way of further example, and with reference to FIGS. 2 and 2A, the installer also has the option of connecting the telephony signal at the triplexer The system of the present invention permits a merging of all three desired signals, including a satellite signal, off-air antenna or cable television, and a telephone signal. Further, these signals can be distributed to multiple locations so that the satellite receivers can work independently of one another. As a result, an installer can simply connect a satellite signal, an off-air antenna, and a telephone signal, all at one easy location in a single multiswitch device. The installer also has the option of connecting the telephone signal at the triplexer instead for providing distribution of dial tone to other triplexers and receivers through the multiswitch in situations where a telephone signal is not present at the multiswitch location. The installer connects the existing cabling to the outputs of the multiswitch device and delivers all three signals over one coax to each receiver location. This triplexer separates out the multiplexed signals so that the installer can connect them to their respective connections on the receiver. This is an easy solution for the installer or the homeowner. A single system that can merge all three signals and distribute them to any location in the home using the single existing cabling and each receiver can act independently of each other. There is a savings in time and the installer does not have multiple devices to connect 28h instead for providing distribution of dial tone to other triplexers and receivers through the multiswitch 26 in situations where a telephone signal is not present at the multiswitch location. The installer connects the existing cabling to the outputs of the multiswitch 26 and delivers all three signals over the one coax 18 to each receiver location. The triplexer 28h separates out the multiplexed signals so that the installer can connect them to their respective connections on the receiver. This is an easy solution for the installer or the homeowner. A single system that can merge all three signals and distribute them to any location in the home using the single existing cabling and each receiver can act independently of each other.

By way of example, when a call comes in, it comes into a DAA device within the system. When the call comes into the DAA, it comes in as a ringing signal. That ringing signal on the DAA device has to be duplicated on all of the SLIC devices on the system. Once the first ring is passed, then the audio from that DAA device has to be patched into all of the audios on the SLIC devices within the system so that the caller ID information can be passed from the DAA device through the SLIC devices to all the satellite receivers. When a second ring comes in again, it comes into the DAA device, but has to be duplicated to all the SLIC devices and so on and so on until the call eventually stops. In an example where the satellite receiver dials out, the system actually has to find the active line connected to one of the DAA devices in the system. It senses that by looking for a DC voltage on any one of the DAA ports which indicates an active line. When the satellite receiver tries to call out, the SLIC device detect control line goes low to signify that event. The microprocessors 70, 84 automatically patch the audio in and audio out from the SLIC device to the audio in and audio out of the particular DAA device that has a DC voltage on it and then takes the DAA device into the off mode which allows the satellite receiver to get a dial tone. Once the satellite receiver gets the dial tone it proceeds with dialing out.

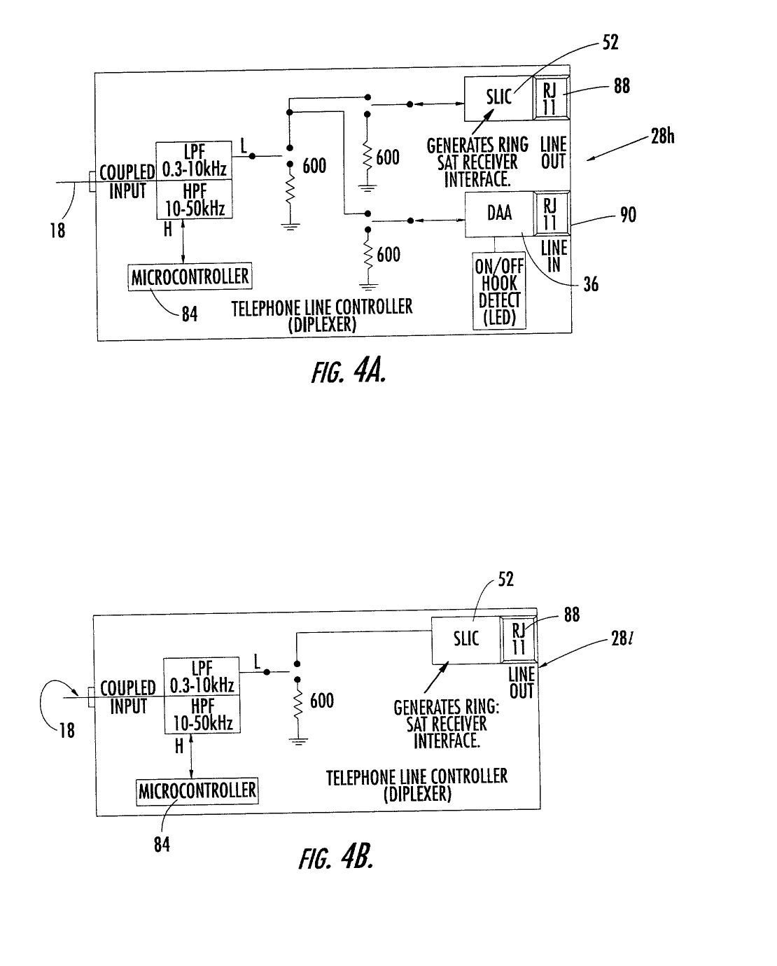

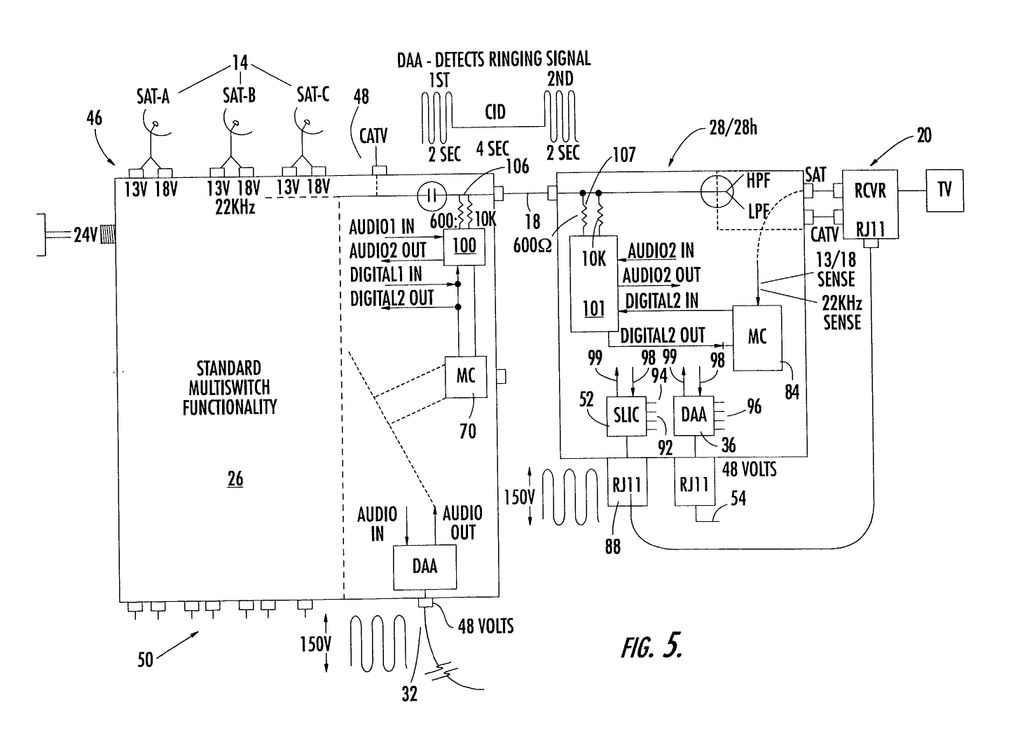

With reference now to FIG. 5, a baseband communication system 100 includes the controllers 70, 84 for controlling the telephony signal 22. The baseband communication system 100 has bidirectional audio and bidirectional digital communication signals transmitted over the single conductor 19 that is the center conductor of the coax cable 18 that runs from the multiswitch 26 to the triplexer 28. The audio signaling 102 is bidirectional in that it is going in both directions at the same time over the coax 18. The digital signaling 104 has bidirectional capability but since in this device the master microcontroller/processor 70 in the multiswitch 26 poles the triplexers 28, the digital communication ends up being a half duplex. Operation of the system 10 is controlled through this hybrid device 100. The audio in signal 102 is biased up 103 on a DC level and then the digital in signal 104 is either set to a 0 or 5 volts. The digital signal either multiplies 105 the audio by a plus one or a minus one and then it is delivered to the center conductor 19 of the coax cable 18 after going through a 600 ohm resistor 106, 107. Part of the hybrid device 100 includes a substractor 108 that operates to subtract the local outgoing signal so that only the received signal is detected at the output of the substractor. The substractor 108 operates with a comparator 110 to recover a returned digital signal 112 and includes an absolute value circuit 114 to recover a returned audio signal 116.

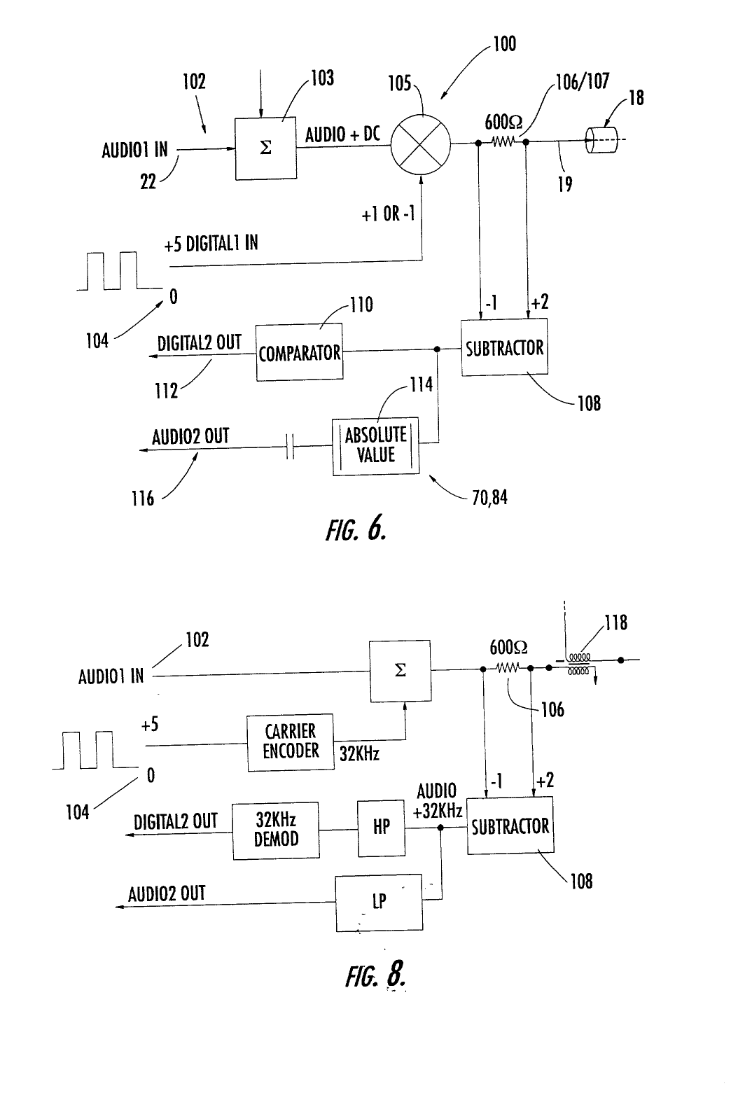

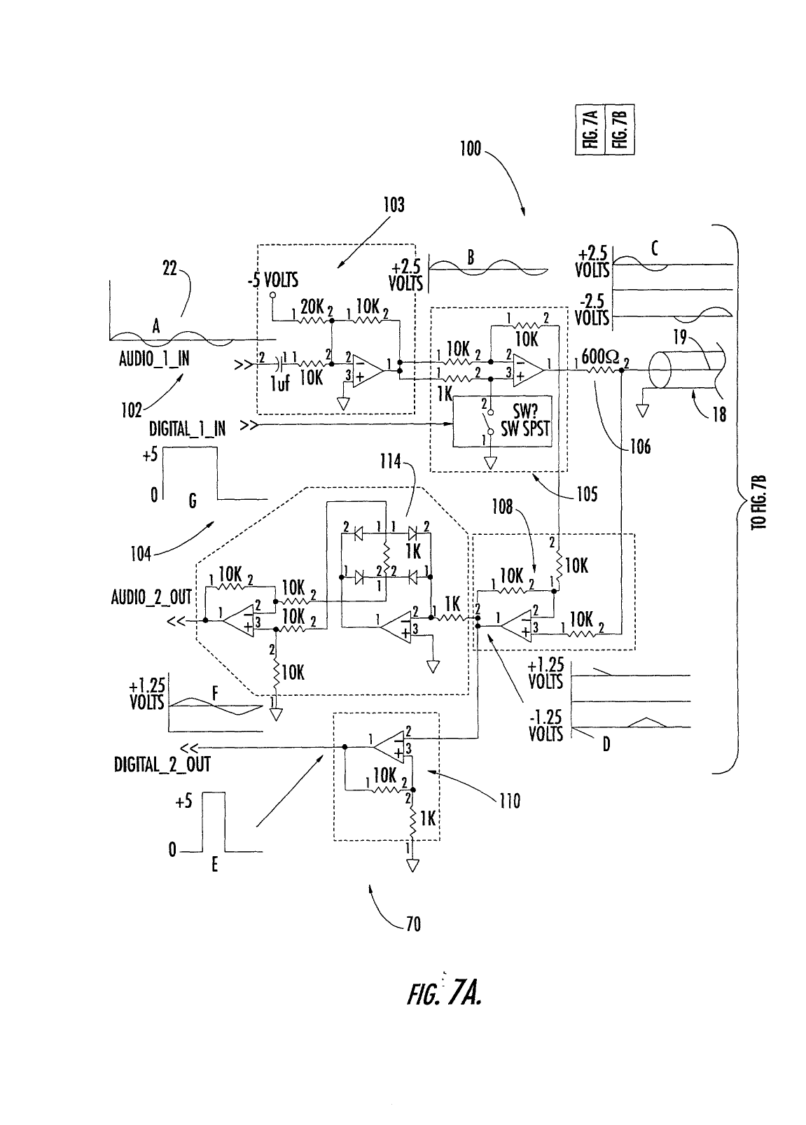

One embodiment of the hybrid device 100 is further detailed with reference to FIG. 6 where a working implementation includes two hybrid devices 100, 101. One hybrid on each side of the coax cable 18 which allows simultaneous transmission of two audio signals bidirectional and two digital signals of bidirectional to be recovered at both ends without interference. The following describes one embodiment of the present invention including the hybrid operating as a voltage multiplexer, which allows analog, the telephony audio, and digital, the controlling signals, to be transmitted simultaneously over the single wire 19 and recovered at a far end. Traditional communication methods use either time domain multiplexing, or frequency domain multiplexing to enable multiple signals to share a single medium. The technique of the present invention herein described employs a voltage multiplexing in which two, or more, baseband signals, that occupy the same frequency spectrum, can be simultaneously transmitted and independently received.

With reference again to the FIG. 6, Audio_{—}1_IN and Digital_{—}1_N originate on the left side and are received on the right as Audio_{—}1_OUT and Digital_{—}1_OUT. Simultaneously Audio_{—}2_IN and Digital_{—}2_{—}1N are being transmitted from the opposite direction and are being detected at Audio_{—}2_OUT and Digital_{—}1_OUT. The Audio_{—}1_IN (Pt. A) is raised to a dc level (in this example) of +2.5 volts (Pt. B). The highs and lows of the Digital_{—}1_IN waveform determined if the analog voltage is inverted at Pt. C. In this example, a high causes the offset analog voltage to remain non-inverted while a low causes the offset analog voltage to invert (Pt. C). The combined signal at Pt. C is received at the far end (Pt. K) without interference with the Audio_{—}2_IN and Digital_{—}2_IN signals that are coming from the far end. This simultaneous bidirectional communication is possible because the receiving amplifier at each end samples and subtracts out the signal from its own transmitter. Therefore at Pt. K, the only signal that exists is the signal present at Pt. C. Because the signal at Pt. K goes through a full wave rectification, the digital information is completely removed with only the analog (Audio_{—}1_IN) remaining (Pt. M). A comparator also acts on the signal at Pt. K to remove the analog audio and recover the Digital_{—}1_IN at Pt. L.

Although not explicitly shown, the Audio_{—}1_IN can be a previously encoded mixture of digital and analog, in which a second level of encoding and decoding would allow two baseband digital signals to be transmitted along with the baseband audio and all three recovered without interference. Multiple levels of encoding and decoding could be used to transmit baseband analog and several baseband digital signals, limited only by the system signal-to-noise performance of real devices.

Unlike that suggested in the art, the triplexer detects the thirteen or eighteen volt signals and determines whether or not the 22 kilohertz signal is present and relays that information to the master microcontroller in the multiswitch. As a result, microcontroller communication provides the telephony information transfer between the multiswitch and the receiver via the triplexer rather than passing the telephony audio voltage signal over the coax.

By way of further supporting description, the SLIC (Subscriber Line Interface Circuit) is the chip that interfaces with the satellite receiver (or telephone). A SLIC interface can generate a ring signal but cannot detect a ring signal. Functionally, the SLIC is the interface your telephone sees at the phone company. The SLIC has audio in and audio out lines and has a DET digital output that goes LOW when the satellite receiver (or a telephone) goes off-hook to dial out. The SLIC has three digital control inputs that are used to set the SLIC in Standby, Ringing, Active, or Caller ID Transmission (OHT) mode depending on circumstances. The DAA (Data Access Arrangement) is a module that detects a ringing signal, but does not generate one. The DM is the device in your home that typically makes the connection of the telephone to the telephone company switch. Consider the DAA to be a phone. The DAA has audio in, and audio out lines, has a ring output line that pulses when a ring signal arrives, and has customer identification (CID) information input control line that is forced low to pass Caller ID information. The DAA further has an “on hook” (OH) input control line that is forced low to answer the incoming phone call.

The hybrid device has a digital input, digital output, analog input, and analog output, and can multiplex bidirectional baseband analog and digital signals onto a single center conductor of the coax cable joining the triplexer and the multiswitch. The analog is 300-3400 Hz. The digital can be any frequency from almost dc to over 100 KHz. 56 Kbaud (28 KHz.) is used in the embodiments herein described by way of example. Voltage division multiplexing is used to keep the analog and digital from interfering with each other. The RF signals range from 5 MHz to 1450 MHz and thus is sufficiently removed from the frequency range of both the telephony analog and digital signals so as to avoid interference. Voltage division multiplexing permits telephony information to be added to the multiswitch inexpensively. The digital transmission in the system includes a burst of data lasting a short period of time. This burst of data generally only occurs every tenth of a second and can interfere with the analog information for 400 microseconds. With respect to frequency domain, the analog signal is transmitted baseband (bidirectional). The digital, which comes along every tenth of a second, is transmitted baseband, for its duration of 400 microseconds. During that time, the digital data is actually used to up-convert the analog out of the way to a spread spectrum frequency until the duration of the digital burst is passed. The analog signal is completely recovered with non-linear processing (the absolute value circuit) so that there is no lose in the analog signal during that time. A switch matrix in the multiswitch allows any analog input/output combination from any hybrid to be connected to any other analog input/output to other hybrid(s). The switch matrix in the triplexer allows the analog input/output from either the DAA of that triplexer or the SLIC of that triplexer to be routed to the hybrid within that triplexer for transmission over the coax cable to the corresponding hybrid in the multiswitch. The multiswitch can then reroute the analog connection via another hybrid to either the SLIC or the DAA in any other triplexer, or to the DAA within the multiswitch, as may be the case.

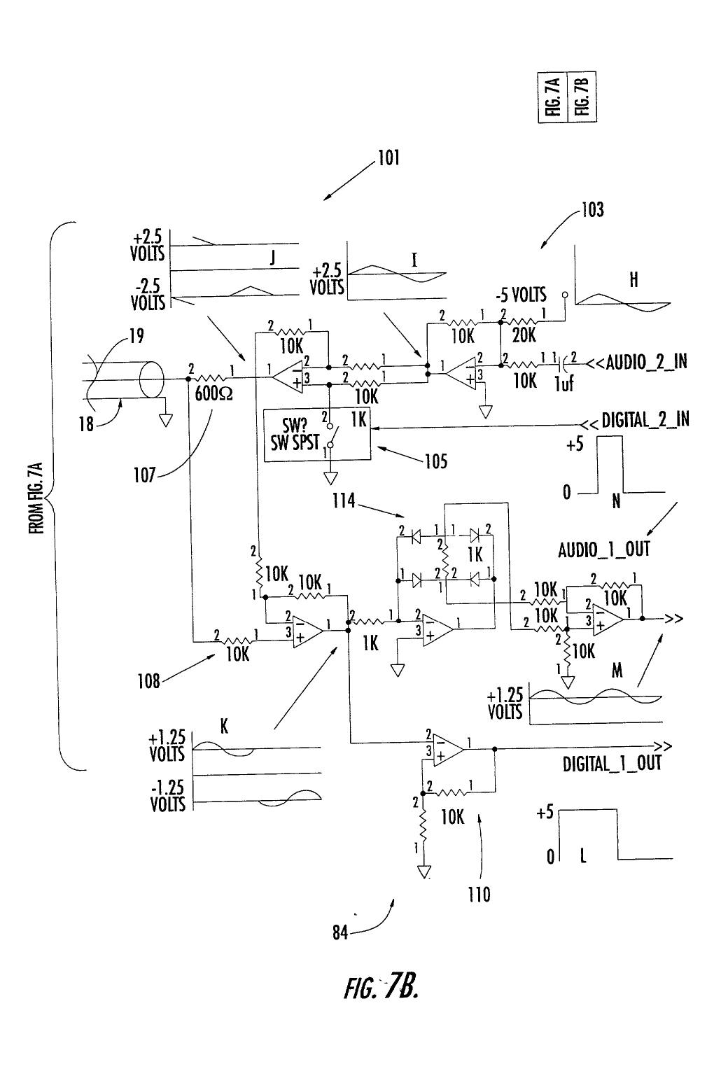

An alternative embodiment to the hybrid device 100 of FIG. 5 is illustrated with reference to FIG. 7 and employs an encoding of both the audio and digital on the same center conductor of the coax cable. Square waves used by the microcontrollers to talk to each other are combined with digital pulses to encode the square wave into a 32 kilohertz carrier and summed that into the audio signal. As a further modification, instead of using the 600 Ohm resistor to couple the signal to the coax cable, a small audio transformer 118 is employed, as illustrated with reference to FIG. 7A. The transformer 118 allows for a coupling of the audio and the digital signals, but also allows the uninhibited passing of the 18 volts and the 22 kilohertz that are needed for control signals for the multiswitch.

Consider the following various situations that may occur.

Case 1. Incoming call (Recall that the SLIC connects to satellite receivers, or telephones; the DAA connects to the phone company.) A 2 second ring signal comes into a DAA somewhere in the system. That 2 second ring signal is regenerated by every SLIC in the system. Immediately after the first ring (which last 2 seconds) the DAA is placed in CID mode. All the SLIC devices are placed in OHT mode for 4 seconds, and the switch matrix sets up a parallel path between the DAA to all the SLIC devices in the system. This passes the incoming caller ID signal to all the satellite receivers (or telephones) in the system. The second ring signal is detected by the DM and regenerated by all the SLIC devices in the system. The SLIC devices are put in standby mode between all subsequent rings. The third ring signal is detected by the DAA and regenerated by all the SLIC devices in the system, and so on. If at any point, a satellite receiver (telephone) were to answer to call, the detect line on the corresponding SLIC would go low, and the OH line of the corresponding DM would be pulled low by the system microcontroller, and the switch matrix would set up an analog path between that SLIC and that DM. When the SLIC DET line goes high, the system knows that the call is terminated and pulls the OH line high on the appropriate DAA and the switch matrix disconnects the analog path.

Case 2. Outgoing call (SLIC devices connect to satellite receivers, or telephones; DM devices connect to the phone company.) The satellite receiver (or telephone) goes off-hook to dial out. The DET line for the corresponding SLIC goes low. The system looks for an active line connected to any DAA in the system. It determines this by the presence of a DC voltage on the line. The system then pulls the OH line low for that DAA and sets up the switch matrix to connect the audio in/out of that DAA to the audio in/out of the corresponding SLIC. The satellite receiver (or telephone) then gets a dial tone and can dial out. (Normally a satellite receiver would wait up to 5 seconds for dial tone before giving up.) When the SLIC DET line goes high, the system knows that the call is terminated and pulls the OH line high on the appropriate DAA and the switch matrix disconnects the analog link.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and alternate embodiments are intended to be included within the scope of the appended claims.

That which is claimed is:

1. A system for transmitting multiple radio frequency and telephony signals across a single cable, the system comprising:
multiple input ports for receiving a plurality of radio frequency signals;
signal processing means operable with the input ports for processing the plurality of radio frequency signals for operation with a switch;
a plurality of switches wherein each one switch of the plurality of switches is operable with the plurality of processed radio frequency signals for providing a selected signal output therefrom in response to a control signal;
a telephony device for receiving a telephony signal, the telephony device electrically connected to a single conductor of the first end of the single cable for transmitting the telephony signal therethrough;
a master controller operable with the plurality of switches for providing the control signal thereto, the master controller operable with the telephony device for receiving telephony information therefrom;
a single cable having opposing first and second ends for transmitting radio frequency signals therebetween, the first end electrically connected with the one switch for receiving the selected radio frequency signal output;
a triplexer having an input port electrically connected to the second end of the single cable for receiving the radio frequency and telephony signals from the single line and providing separate satellite, cable television and telephony output signals to a receiver, the triplexer further having a controller for communicating with the master controller through the single conductor wire and an interface device for connection to the receiver; and
a baseband communications system operable with the controllers and the telephony device for modifying the telephony signal as characterized by the control signal for transmitting a modified telephony signal through a single conductor wire of the single cable.

2. A system according to claim 1, wherein the plurality of radio frequency signals includes satellite and cable television signals.

3. A system according to claim 2, further comprising a cable modem for upstream signal transmission to a broadcast provider.

4. A system according to claim 1, wherein the signal processing means comprise amplifying and filtering of the radio frequency signals.

5. A system according to claim 1, further comprising a coupling circuit for distributed coupling of the plurality of radio frequency signals to the plurality of switches.

6. A system according to claim 1, wherein the telephony device includes a data access arrangement device operable with an outside telephone line for receiving the telephony signal and providing an audio input and audio output signal connection to the single conductor wire.

7. A system according to claim 1, wherein the master controller comprises a microprocessor.

8. A system according to claim 1, wherein the single cable comprises a coaxial cable having an inner conductor, and wherein the inner conductor includes the single conductor wire.

9. A system according to claim 1, wherein the interface device of the triplexer comprises a subscriber line interface circuit for transmitting a telephony signal to a receiver.

10. A system according to claim 1, wherein the baseband communications system comprises first and second modifying devices comprising means for modifying the telephony signal based on a digital control signal from the controllers for providing a modified audio signal characterized by a digital waveform and full wave rectifying means for removing the digital waveform characterization, thus providing the an analog voltage signal as an audio signal at the conductor ends, characteristic of the first audio input signal, and wherein the first modifying device is operable with the master controller and the second modifying device is operable the controller of the triplexer.

11. A system for transmitting multiple radio frequency and telephony signals across a single cable, the system comprising:
a switch for receiving a plurality of radio frequency signals and providing a selected signal output to a coaxial cable in response to a control signal;
a telephony device for receiving a telephony signal;
a controller operable with the switch for providing the selected signal output and operable with the telephony device for receiving telephony information therefrom; and
a baseband communications system operable with the controller and the telephony device for modifying the telephony signal as characterized by a control signal for transmitting a modified telephony signal through a single center conductor wire of the coaxial cable .

12. A system according to claim 11, further comprising a triplexer for connection to the single cable for simultaneously receiving the modified telephony signal and the selected radio frequency signal therefrom and providing separate satellite, cable television and telephony signals to the receiver, the triplexer further having a controller communicating with the controller through the single conductor wire and an interface device for connection to a receiver.

13. A system according to claim 12, wherein the triplexer comprises a telephony output port, a satellite signal output port, and a terrestrial cable output port for connection to a receiver.

14. A system according to claim 12, wherein the interface device comprises a subscriber line interface circuit.

15. A system according to claim 11, wherein the telephony device includes a data access arrangement device operable with an outside telephone line for receiving the telephony signal and providing an audio input and audio output signal connection to the single center conductor wire.

16. A system according to claim 11, wherein the baseband communications system comprises means for modifying the telephony signal based on a digital control signal from the controller for providing a modified audio signal characterized by a digital waveform and full wave rectifying means for removing the digital waveform characterization, thus providing the an analog voltage signal as an audio signal characteristic of the telephony signal.

17. A method for transmitting multiple radio frequency and telephony signals across a single cable, the method comprising:
receiving a plurality of radio frequency signals;
processing the radio frequency signals for transmitting to a switch;
selecting one radio frequency signal from the plurality of radio frequency signals for transmission through a single cable;
receiving a telephony signal;
modifying the telephony signal as characterized by a digital control signal for transmitting a modified telephony signal through a single conductor wire of the single cable;
receiving the selected radio frequency signal and the modified telephony signal;
processing the modified telephony signal for reforming the telephony signal from the modified telephony signal; and
transmitting the telephony signal and the selected radio frequency signal to a receiver.

18. A method according to claim 17, wherein the plurality of radio frequency signals includes satellite and cable television signals.

19. A method according to claim 17, wherein the radio frequency signal processing comprises amplifying and filtering of the radio frequency signals.

20. A method according to claim 17, wherein modifying the telephony signal comprises:
providing a first analog voltage signal representing the telephony signal;
providing a first digital waveform characterized by a high voltage level and a low voltage level;
modifying the first analog voltage signal to a preselected voltage level based on the first digital waveform for providing a first modified audio signal characterized by the first digital waveform high and low voltage levels;
transmitting the first modified audio signal through the single conductor from a conductor first end to a conductor second end;
receiving the first modified audio signal at the conductor second end;
full wave rectifying the first modified audio signal for removing the first digital waveform characterization, thus providing the first analog voltage signal as a first audio output signal at the conductor second end characteristic of the telephony signal;
providing a second analog voltage signal representing a second telephony signal;
providing a second digital waveform characterized by a high voltage level and a low voltage level;
modifying the second analog voltage signal to a preselected voltage level based on the second digital waveform for providing a second modified audio signal characterized by the second digital waveform high and low voltage levels;
transmitting the second modified audio signal through the single conductor from a conductor second end to the conductor first end;
receiving the second modified audio signal at the conductor first end; and
full wave rectifying the second modified audio signal for removing the second digital waveform characterization, thus providing the second analog voltage signal as a second audio output signal at the conductor first end characteristic of the second telephony signal.
